(19) United States
(12) Patent Application Publication
(10) Pub. No.: US 2020/0292862 A1
(43) Pub. Date: Sep. 17, 2020

(54) DISPLAY-PANEL MOTHERBOARD AND FABRICATING METHOD THEREOF

(71) Applicants: BOE TECHNOLOGY GROUP CO., LTD., Beijing (CN); HEFEI BOE OPTOELECTRONICS TECHNOLOGY CO., LTD., Anhui (CN)

(72) Inventors: Zhaozhe XU, Beijing (CN); Ji LI, Beijing (CN); Zhiyang GAO, Beijing (CN); Lisen WANG, Beijing (CN)

(21) Appl. No.: 15/776,940

(22) PCT Filed: Oct. 9, 2017
(86) PCT No.: PCT/CN2017/105356

§ 371 Date: May 17, 2018

(30) Foreign Application Priority Data
Mar. 2, 2017 (CN) 201710121149.9

(51) Int. Cl. G02F 1/1339

(52) U.S. Cl. CPC G02F 1/13392; G02F 2001/133354

(57) ABSTRACT

The present disclosure provides a display-panel motherboard and a fabricating method thereof. The display-panel motherboard includes a first motherboard and a second motherboard arranged opposite to each other, the display-panel motherboard is divided into a plurality of sub-panel regions arranged in an array, and a surrounding region other than all of the sub-panel regions, sealing glue for bonding the first motherboard to the second motherboard is applied within the surrounding region on a periphery of the display-panel motherboard, each sub-panel region is provided therein with sealant for bonding the first motherboard to the second motherboard, and first liquid crystals are provided within a closed space between the first motherboard and the second motherboard at an inner side of the sealing glue and at an outer side of the sealant within the individual sub-panel regions.

### CROSS-REFERENCE TO RELATED APPLICATION

This is a National Phase Application filed under 35 U.S.C. 371 as a national stage of PCT/CN2017/105356, filed Oct. 9, 2017, an application claiming the benefit of priority to the Chinese Patent Application No. 201710121149.9 filed on Mar. 2, 2017, the contents of which are incorporated herein in their entirety by reference.

### TECHNICAL FIELD

The present disclosure relates to the field of display technology, in particular, to a display-panel motherboard and a fabricating method of the display-panel motherboard.

### BACKGROUND

Thin film transistor-liquid crystal display (TFT-LCD) is formed by aligning and assembling an array substrate and a color filter substrate to form a cell by means of sealant and enclosing the liquid crystals within the cell.

On the periphery of TFT-LCD, the internal and the external atmospheres of the sealant are different from each other, specifically, in that: 1) there are liquid crystals at the inner side of the sealant, while there is vacuum atmosphere at the outer side of the sealant, resulting in different atmospheres at the two sides of the sealant; and 2) there are liquid crystals and spacers for supporting to maintain the cell gap at the inner side of the sealant, while there is no supporter in a region at the outer side of the sealant and between the two parallel substrates (i.e., the array substrate and the color filter substrate), resulting in different supporting conditions at two sides of the sealant. Consequently, the inner side and the outer side of the sealant are subjected to different forces, which is prone to cause deformation of the array substrate and the color filter substrate during aligning and assembling them, resulting in a higher or a lower periphery of the display panel, i.e., a non-uniform cell gap on the periphery of the display panel, and therefore adverse effects such as yellowing display, black edge, mura, and the like, may be occur on the periphery of the display panel.

### SUMMARY

The present disclosure provides a display-panel motherboard and a fabricating method.

In an embodiment, the display-panel motherboard includes a first motherboard and a second motherboard arranged opposite to each other, the display-panel motherboard is divided into a plurality of sub-panel regions arranged in an array, and a surrounding region other than all of the sub-panel regions, sealing glue for bonding the first motherboard to the second motherboard is provided within the surrounding region on a periphery of the display-panel motherboard, each sub-panel region is provided therein with sealant for bonding the first motherboard to the second motherboard, and first liquid crystals are provided within a closed space between the first motherboard and the second motherboard at an inner side of the sealing glue and at an outer side of the sealant within the individual sub-panel regions.

In some embodiments, the display-panel motherboard further includes a plurality of supporting components provided within the closed space between the first motherboard and the second motherboard at an inner side of the sealing glue and at an outer side of the sealant within the individual sub-panel regions.

In some embodiments, the plurality of supporting components are arranged in an array.

In some embodiments, the supporting components are made of a photosensitive polymer material which is doped into the first liquid crystals.

In some embodiments, the photosensitive polymer material is an acrylic material or a polyimide material.

In some embodiments, the first liquid crystals are doped with polymerization catalyst.

In some embodiments, the first motherboard is an array-substrate motherboard, and the second motherboard is a color filter-substrate motherboard; or, the first motherboard is a color filter-substrate motherboard, and the second motherboard is an array-substrate motherboard.

The present disclosure further provides a method for fabricating a display-panel motherboard including steps:

dividing a first motherboard into a plurality sub-panel regions arranged in an array and a surrounding region other than all of the sub-panel regions;

applying sealing glue within the surrounding region on a periphery of the first motherboard;

dripping liquid crystals into a region enclosed by the sealing glue; and

aligning and assembling the first motherboard and the second motherboard to form a cell so as to form a display-panel motherboard.

In some embodiments, before the step of aligning and assembling the first motherboard and the second motherboard to form a cell, the method includes a step of:

forming a plurality of supporting components within a region between an inner side of the sealing glue and an outer side of sealant within the individual sub-panel regions.

In some embodiments, the step of forming a plurality of supporting components within a region at an inner side of the sealing glue and an outer side of sealant within the individual sub-panel regions includes:

doping a photosensitive polymer material into liquid crystals which are located within the region at the inner side of the sealing glue and the outer side of the sealant within the individual sub-panel regions; and

irradiating the photosensitive polymer material with light having a predetermined wavelength via a mask, so as to form the plurality of supporting components at exposure positions.

In some embodiments, the step of forming a plurality of supporting components within a region at an inner side of the sealing glue and an outer side of sealant within the individual sub-panel regions further includes:

doping polymerization catalyst into the liquid crystals within the region at the inner side of the sealing glue and the outer side of the sealant within the individual sub-panel regions.

In some embodiments, before the step of irradiating the photosensitive polymer material with light having a predetermined wavelength via a mask, the method includes:

acquiring a distribution of cell gaps between the first motherboard and the second motherboard;

the step of irradiating the photosensitive polymer material with light having a predetermined wavelength via a mask includes:

preparing a corresponding mask based on the acquired distribution, and irradiating the photosensitive polymer material with light having a predetermined wavelength via the mask to adjust distribution positions of the supporting components.

In some embodiments, the light having a predetermined wavelength is ultraviolet light.

In some embodiments, the photosensitive polymer material is an acrylic material or a polyimide material.

In some embodiments, the first motherboard is an array-substrate motherboard, and the second motherboard is a color filter-substrate motherboard; or, the first motherboard is a color filter-substrate motherboard, and the second motherboard is an array-substrate motherboard.

### BRIEF DESCRIPTION OF THE FIGURES

FIG. 1 is a schematic diagram of a structure of a display-panel motherboard according to an embodiment of the present disclosure;

FIG. 2 is a cross-sectional view of the display-panel motherboard as shown in FIG. 1;

FIG. 3 is a schematic diagram of a structure of another display-panel motherboard according to an embodiment of the present disclosure;

FIG. 4 is a cross-sectional view of the display-panel motherboard as shown in FIG. 3; and

FIG. 5 is a flow chart of a fabricating method of a display-panel motherboard according to an embodiment of the present disclosure.

### DETAILED DESCRIPTION

The display-panel motherboard and the fabricating method thereof according to the embodiments of the present disclosure will be described in detail below in conjunction with drawings in order that a person skilled in the art can understand the technical solutions of the present disclosure better. The present disclosure provides the display-panel motherboard and the fabricating method thereof to solve at least one of the problems that the cell gap on the periphery of the display panel is non-uniform and the adverse effects such as yellowing display, black edge, mura, and the like, occur on the periphery of the display panel caused by the different applied forces at the inner and the outer side of the sealant in the existing display.

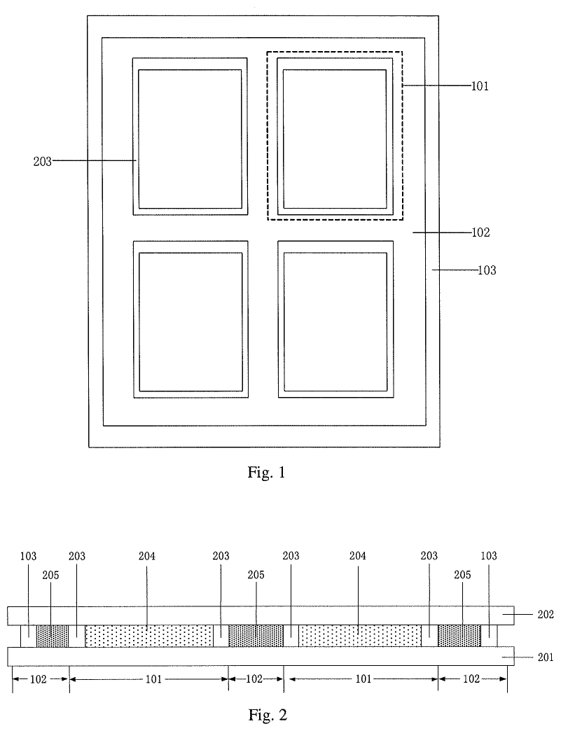

FIG. 1 is a schematic diagram of a structure of a display-panel motherboard according to an embodiment of the present disclosure. As shown in FIG. 1, the display-panel motherboard includes a first motherboard and a second motherboard opposite to each other. The display-panel motherboard is divided into a plurality of sub-panel regions 101 arranged in an array, and a surrounding region 102 other than all of the sub-panel regions 101. Sealing glue 103 for bonding the first motherboard to the second motherboard is provided within the surrounding region 102 on the periphery of the display-panel motherboard. Each sub-panel region 101 is provided therein with the sealant 203 for bonding the first motherboard to the second motherboard so that: a closed space is formed between the first and the second motherboards at the inner side of the sealing glue 103 and at the outer side of sealant 203 within the individual sub-panel regions 101; closed spaces are further formed between the first and the second motherboards at the inner side of the sealant 203 within the individual sub-panel regions 101, respectively; meanwhile, between the individual sub-panel regions 101, closed spaces are further formed between the first and the second motherboards at the outer side of the sealant 203 within the individual sub-panel regions 101. Furthermore, first liquid crystals are provided within the closed space located between the first and the second motherboards at the inner side of the sealing glue 103 and at the outer side of sealant 203 within the individual sub-panel regions 101; between the individual sub-panel regions 101, first liquid crystals are further provided within the closed spaces located between the first and the second motherboards at the outer side of the sealant 203 within the individual sub-panel regions 101; second liquid crystals may be provided within the closed spaces located between the first and the second motherboards at the inner side of the sealant 203 within the individual sub-panel regions 101. As shown in FIG. 1, the display-panel motherboard provided by the present embodiment has four display panels arranged in an array, one display panel corresponding to one sub-panel region 101. According to the technical solution provided by the present embodiment, since the sealing glue 103 is disposed within the surrounding region on the periphery of the display-panel motherboard, and the first liquid crystals are disposed between the first and the second motherboards at the inner side of the sealing glue 103 and at the outer side of the sealant 203 within the individual sub-panel regions 101, it is ensured that the internal and the external environments of the sealant 203 are consistent since there are liquid crystals at both sides (the inner side and the outer side) of the sealant 203. In addition, since the liquid crystals at the inner side and the outer side of the sealant 203 can act as supporters, the supporting conditions at the two sides of the sealant are substantially consistent. Consequently, the forces applied to the inner side and the outer side of the sealant 203 are substantially the same, which may avoid occurrence of a deformation of the first and the second motherboards as much as possible during they are aligned and assembled to form a cell, so that a final display panel with a more uniform cell gap in the surrounding region may be formed, and thus various adverse effects caused by a non-uniform cell gap may be avoided as much as possible.

Specifically, in the present embodiment, the first motherboard is an array-substrate motherboard, and the second motherboard is a color filter-substrate motherboard. FIG. 2 is a cross-sectional view of the display-panel motherboard as shown in FIG. 1. As shown in FIG. 2, an array-substrate motherboard 201 and a color filter-substrate motherboard 202 are provided opposite to each other. A surrounding region 102 is provided therein with first liquid crystals 205, and each sub-panel region 101 is provided therein with sealant 203 and second liquid crystals 204 located at the inner side of the sealant 203. The second liquid crystals 204 within the individual sub-panel regions 101 may be the same as or different from the first liquid crystals 205 within the surrounding region 102. In some embodiments, a material of the first liquid crystals 205 within the surrounding region 102 should be a material having physical properties, such as the thermal expansion coefficient, the viscosity, the flowability, and the like, approximate to those of a material of the second liquid crystals 204. In addition, after the display-panel motherboard is cut, the first liquid crystals within the surrounding region may be recycled and reused when a display-panel motherboard is fabricated next time, thereby reducing the production cost. According to the technical solution provided by the present embodiment, since the second liquid crystals 204 are disposed within the sub-panel regions 101, and the first liquid crystals 205 are disposed within the surrounding region 102, both sides (the inner side and the outer side) of the sealant 203 within the individual sub-panel regions may be supported by liquid crystals; thereby it is ensured that the internal and the external environments of the sealant 203 are consistent, and the supporting conditions at the two sides of the sealant are substantially consistent.

In the display-panel motherboard provided by the present embodiment, the display-panel motherboard includes a first motherboard and a second motherboard opposite to each other, the display-panel motherboard being divided into a plurality of sub-panel regions arranged in an array, and a surrounding region other than all of the sub-panel regions. Sealing glue for bonding the first motherboard to the second motherboard is provided within the surrounding region on the periphery of the display-panel motherboard. Each sub-panel region is provided therein with sealant for bonding the first motherboard to the second motherboard so that: a closed space is formed between the first and the second motherboards at the inner side of the sealing glue and at the outer side of the sealant within the individual sub-panel regions; also, between the individual sub-panel regions, closed spaces are further formed between the first and the second motherboards at the outer side of the sealant within the individual sub-panel regions; and closed spaces are further formed between the first and the second motherboards at the inner side of the sealant within the individual sub-panel regions, respectively. Furthermore, first liquid crystals are provided within the closed space located between the first and the second motherboards at the inner side of the sealing glue and at the outer side of sealant within the individual sub-panel regions; between the individual sub-panel regions, first liquid crystals are further provided within the closed spaces located between the first and the second motherboards at the outer side of the sealant within the individual sub-panel regions; second liquid crystals may be provided within the closed spaces located between the first and the second motherboards at the inner side of the sealant within the individual sub-panel regions. According to the technical solution provided by the present embodiment, since the sealing glue is disposed within the surrounding region on the periphery of the display-panel motherboard, and the first liquid crystals are disposed between the first and the second motherboards at the outer side of the sealant within the individual sub-panel regions and at the inner side of the sealing glue, it is ensured that the internal and the external environments of the sealant are consistent since there are liquid crystals at both sides (the inner side and the outer side) of the sealant within the individual sub-panel regions. In addition, since the liquid crystals at the inner side and the outer side of the sealant can act as supporters, the supporting conditions at the two sides of the sealant are substantially consistent. Consequently, the forces applied to the inner side and the outer side of the sealant are substantially the same, which may avoid occurrence of a deformation of the first motherboard (for example, the array substrate) and the second motherboard (for example, the color filter substrate) as much as possible during they are aligned and assembled to form a cell, so that a final display panel with a more uniform cell gap may be formed, and thus various adverse effects caused by a non-uniform cell gap may be avoided as much as possible.

FIG. 3 is a schematic diagram of a structure of another display-panel motherboard according to an embodiment of the present disclosure. As shown in FIG. 3, the display-panel motherboard includes a first motherboard and a second motherboard opposite to each other. The display-panel motherboard is divided into a plurality of sub-panel regions 101 arranged in an array, and a surrounding region 102 other than all of the sub-panel regions 101. Sealing glue 103 for bonding the first motherboard to the second motherboard is provided within the surrounding region 102 on the periphery of the display-panel motherboard. Each sub-panel region 101 is provided therein with the sealant 203 for bonding the first motherboard to the second motherboard so that: a closed space is formed between the first and the second motherboards at the inner side of the sealing glue 103 and at the outer side of sealant 203 within the individual sub-panel regions 101; also, between the individual sub-panel regions 101, closed spaces are further formed between the first and the second motherboards at the outer side of the sealant 203 within the individual sub-panel regions 101; and closed spaces are further formed between the first and the second motherboards at the inner side of the sealant 203 within the individual sub-panel regions 101, respectively. Furthermore, first liquid crystals are provided within the closed space located between the first and the second motherboards at the inner side of the sealing glue 103 and at the outer side of sealant 203 within the individual sub-panel regions 101; between the individual sub-panel regions 101, first liquid crystals are further provided within the closed spaces located between the first and the second motherboards at the outer side of the sealant within the individual sub-panel regions1; second liquid crystals may be provided within the closed spaces located between the first and the second motherboards at the inner side of the sealant 203 within the individual sub-panel regions 101. Referred to FIG. 3, the display-panel motherboard provided by the present embodiment has four display panels arranged in an array, one display panel corresponding to one sub-panel region 101.

In addition to the second liquid crystals, a plurality of spacers are provided at the inner side of the sealant 203 within the individual sub-panel regions 101 so as to maintain the cell gap properly in each sub-panel region. Accordingly, in the present embodiment, in order to maintain the cell gap properly on the periphery of the display-panel motherboard, a plurality of supporting components 301 are further provided in the closed space located between the first and the second motherboards at the inner side of the sealing glue 103 and at the outer side of the sealant 203 within the individual sub-panel regions 101, and provided in the closed spaces located between the first and the second motherboards at the outer side of the sealant 203 within the individual sub-panel regions 101 and between the individual sub-panel regions 101. In some embodiments, the plurality of supporting components 301 are arranged in an array; the material for forming the supporting components 301 is a photosensitive polymer material which is doped in the first liquid crystals. Furthermore, in some embodiments, the photosensitive polymer material is an acrylic material or a polyimide material. Furthermore, polymerization catalyst may be doped in the first liquid crystals to accelerate the polymerization procedure.

The photosensitive polymer material can be polymerized by the irradiation of light having a specific wavelength (such as UV light), and then form the supporting components 301 (also called polymer blocking structures) at exposure positions. The photosensitive polymer material which is not located at the exposure positions will not be polymerized. Thus, the positions at which the polymer blocking structures be formed may be controlled by adjusting the positions of trenches/openings in a mask used for exposing the photosensitive polymer material. In a practical production procedure, a production staff may first test the cell gap data after the first and the second motherboards are aligned and assembled to form a cell, and then generate a corresponding mask based on a practical fluctuation of the cell gap data. Thereby, the cell gap may be corrected after the first and the second motherboards are aligned and assembled to form a cell, resulting in a uniform cell gap in the display-panel motherboard as formed subsequently.

According to the technical solution provided by the present embodiment, the sealing glue 103 is disposed within the surrounding region on the periphery of the display-panel motherboard, the first liquid crystals and the plurality of the supporting components 301 are disposed in the closed space between the first and the second motherboard at the inner side of the sealing glue 103 and at the outer side of the sealant 203 within the individual panel regions 101, and the first liquid crystals and the plurality of the supporting components 301 are further disposed in the closed space between the first and the second motherboard at the outer side of the sealant 203 within the individual panel regions 101 and between the individual panel regions 101; in this case, there are liquid crystals and a plurality of spacers acting as supporters at the inner side of the sealant 203 within the individual sub-panel regions, while there are liquid crystals and a plurality of supporting components 301 acting as supporters at the outer side of the sealant 203, and thereby ensuring consistent supporting conditions at the two sides of the sealant. In this manner, the forces applied to the inner and the outer sides of the sealant are identical, which may avoid occurrence of deformation of the first and the second motherboards during they are aligned and assembled to form a cell, so that a final display panel with a uniform cell gap may be formed, and thus various adverse effects caused by a non-uniform cell gap may be avoided.

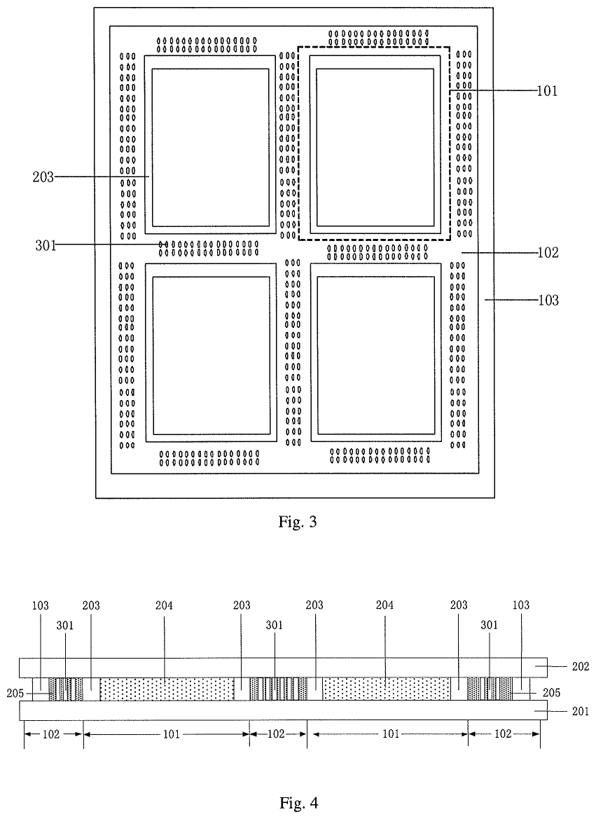

Specifically, in the present embodiment, the first motherboard is an array-substrate motherboard, and the second motherboard is a color filter-substrate motherboard. FIG. 4 is a cross-sectional view of the display-panel motherboard as shown in FIG. 3. As shown in FIG. 4, an array-substrate motherboard 201 and a color filter-substrate motherboard 202 are provided opposite to each other. A surrounding region 102 is provided therein with first liquid crystals 205 and a plurality of supporting components 301, and each sub-panel region 101 is provided therein with sealant 203, second liquid crystals 204 and a plurality of spacers (not shown in figures). The second liquid crystals 204 within the individual sub-panel regions 101 may be the same as or different from the first liquid crystals 205 within the surrounding region 102. Preferably, a material of the first liquid crystals 205 within the surrounding region 102 should be a material having physical properties, such as the thermal expansion coefficient, the viscosity, the flowability, and the like, approximate to those of a material of the second liquid crystals 204. In addition, after the display-panel motherboard is cut, the first liquid crystals within the surrounding region may be recycled and reused when a display-panel motherboard is fabricated at a next time, and thereby reducing the production cost. According to the technical solution provided by the present embodiment, since the second liquid crystals 204 and the plurality of the spacers are disposed within the sub-panel regions 101, and the first liquid crystals 205 and the plurality of supporting components 301 are disposed within the surrounding region 102, both sides (the inner side and the outer side) of the sealant within the individual sub-panel regions may be supported; thereby it is ensured that the internal and the external environments of the sealant are consistent, and the supporting conditions at the two sides of the sealant are substantially consistent.

In the display-panel motherboard provided by the present embodiment, the display-panel motherboard includes a first motherboard and a second motherboard opposite to each other, the display-panel motherboard being divided into a plurality of sub-panel regions arranged in an array, and a surrounding region other than all of the sub-panel regions. Sealing glue for bonding the first motherboard to the second motherboard is provided within the surrounding region on the periphery of the display-panel motherboard. Each sub-panel region is provided therein with sealant for bonding the first motherboard to the second motherboard so that: a closed space is formed between the first and the second motherboards at the inner side of the sealing glue and at the outer side of the sealant within the individual sub-panel regions; also, between the individual sub-panel regions 101, closed spaces are further formed between the first and the second motherboards at the outer side of the sealant 203 within the individual sub-panel regions 101; and closed spaces are further formed between the first and the second motherboards at the inner side of the sealant within the individual sub-panel regions, respectively. Furthermore, first liquid crystals and a plurality of supporting components are provided within the closed space located between the first and the second motherboards at the inner side of the sealing glue and at the outer side of sealant within the individual sub-panel regions, and first liquid crystals and a plurality of supporting components are further provided within the closed spaces located between the first and the second motherboards at the outer side of the sealant 203 within the individual sub-panel regions 101 and between the individual sub-panel regions 101; second liquid crystals and a plurality of spacers may be provided within the closed spaces located between the first and the second motherboards at the inner side of the sealant within the individual sub-panel regions. According to the technical solution provided by the present embodiment, since the sealing glue is disposed within the surrounding region on the periphery of the display-panel motherboard, and the first liquid crystals and the plurality of supporting components are disposed within the closed space located between the first and the second motherboards at the outer side of the sealant within the individual sub-panel regions and at the inner side of the sealing glue, it is ensured that the internal and the external environments of the sealant are consistent since there are liquid crystals at both sides (the inner side and the outer side) of the sealant within the individual sub-panel regions. In addition, since the liquid crystals and the plurality of spacers at the inner side of the sealant can act as supporters, and the liquid crystals and the plurality of supporting components at the outer side of the sealant can also act as supporters, the supporting conditions at the two sides of the sealant are substantially consistent. Consequently, the forces applied to the inner side and the outer side of the sealant are substantially the same, which may avoid the occurrence of deformation of the first motherboard (such as an array substrate) and the second motherboard (such as a color filter substrate) during they are aligned and assembled to form a cell, so that a final display panel with a more uniform cell gap may be formed, and thus various adverse effects caused by a non-uniform cell gap may be avoided.

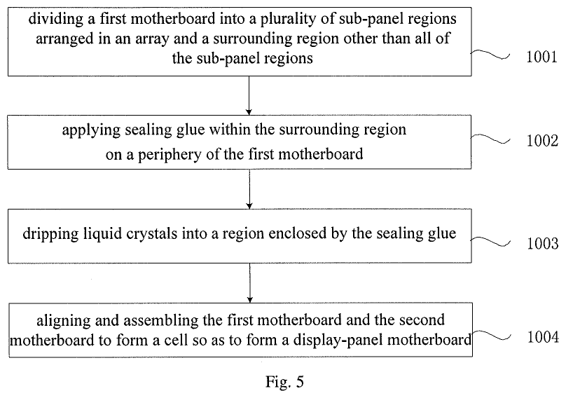

FIG. 5 is a flow chart of a fabricating method of a display-panel motherboard according to an embodiment of the present disclosure. As shown in FIG. 5, the fabricating method of a display-panel motherboard includes the following steps.

Step 1001: dividing a first motherboard into a plurality sub-panel regions arranged in an array and a surrounding region other than all of the sub-panel regions.

Step 1002: applying sealing glue within the surrounding region on the periphery of the first motherboard.

Step 1003: dripping liquid crystals into a region enclosed by the sealing glue.

Step 1004: aligning and assembling the first motherboard and a second motherboard to form a cell so as to form a display-panel motherboard.

It is well known to a person skilled in the art that, prior to Step 1003, the method further includes a step of providing sealant within the individual sub-panel regions and forming a plurality of spacers within regions enclosed by the sealant. In some embodiments, before the step of aligning and assembling the first motherboard and the second motherboard to form a cell (i.e., Step 1004), the method includes a step of forming a plurality of supporting components within a region between an inner side of the sealing glue and an outer side of the sealant within the individual sub-panel regions.

In some embodiments, the step of forming the plurality of supporting components includes: doping a photosensitive polymer material into liquid crystals which are located within the region between the inner side of the sealing glue and the outer side of the sealant within the individual sub-panel regions, and into liquid crystals which are located within regions between the first and the second motherboard at the outer side of the sealant 203 within the individual sub-panel regions 101 and between the individual sub-panel regions 101; irradiating the photosensitive polymer material by using light having a predetermined wavelength via a mask, so as to form a plurality of supporting components at exposure positions. The liquid crystals within the individual sub-panel regions may be the same as or different from the liquid crystals within the surrounding region. In some embodiments, the light having a predetermined wavelength is ultraviolet (UV) light. Furthermore, in order to accelerating the polymerization procedure, polymerization catalyst may be doped into the liquid crystal located within the region at the inner side of the sealing glue and at the outer side of the sealant within the individual sub-panel regions, and into the liquid crystals located within the regions between the first and the second motherboard at the outer side of the sealant 203 within the individual sub-panel regions 101 and between the individual sub-panel regions 101 (i.e., the liquid crystals within the surrounding region). Before producing the products on a large scale, position optimization of the supporting components may be performed on a test motherboard after being aligned and assembled to form a cell. Then, an optimal distribution design for the supporting components is made in view of the product design. Thereafter, mass production is done using the above distribution design for the supporting components, and thus production efficiency may be improved and the distribution of the supporting components can be optimized as well. Finally, the display panel motherboard is cut so as to be divided into single display panels which will be processed in subsequent technological processes after being subject to cleaning and edge polishing.

In the present embodiment, before the step of irradiating the photosensitive polymer material by using light having a predetermined wavelength via a mask, the method includes: acquiring a distribution of cell gaps between the first and the second motherboards; the step of irradiating the photosensitive polymer material by using light having a predetermined wavelength includes: preparing a corresponding mask based on the acquired distribution, and irradiating the photosensitive polymer material by using light having a predetermined wavelength via the mask to adjust the distribution positions of the supporting components. In some embodiments, the photosensitive polymer material is an acrylic material or a polyimide material. In a practical production procedure, a production staff may first test the cell gap data after the first motherboard (such as an array-substrate motherboard) and the second motherboard (such as a color filter-substrate motherboard) are aligned and assembled to form a cell, and then adjust exposure openings in the mask in accordance with a practical fluctuation of the cell gap artificially to control the positions of the supporting components, so that the artificial adjustment of the cell gap is achieved. In this manner, since the liquid crystals and the plurality of spacers at the inner side of the sealant can act as support, and the liquid crystals and the plurality of supporting components at the outer side of the sealant can also act as supporters, there are supporters at both the inner and the outer sides of the sealant. Consequently, the forces applied to the inner side and the outer side of the sealant are the same, which may avoid occurrence of deformation of the first and the second motherboards during they are aligned and assembled to form a cell, so that a final display panel with a uniform cell gap on the periphery thereof may be formed, and thus various adverse effects caused by a non-uniform cell gap may be avoided.

According to the fabricating method of a display panel motherboard provided by the resent embodiment, the fabricating method of a display-panel motherboard includes: dividing a first motherboard into a plurality sub-panel regions arranged in an array and a surrounding region other than all of the sub-panel regions; applying sealing glue within the surrounding region on the periphery of the first motherboard; dripping liquid crystals into a region enclosed by the sealing glue; aligning and assembling the first motherboard and the second motherboard to form a display-panel motherboard. In the technical solution provided by the present embodiment, since the sealing glue is provided within the surrounding region on the periphery of the display-panel motherboard, and liquid crystals are dripped into the region enclosed by the sealing glue, there are supporters at both the inner and the outer sides of the sealant, and thereby it is ensured that the internal and the external environments of the sealant are consistent. In addition, a plurality of supporting components are formed within the region located between the inner side of the sealing glue and the outer side of the sealant within the individual sub-panel regions, and formed within the regions located between the sealant within the individual sub-panel regions. In this manner, the liquid crystals and the plurality of spacers at the inner side of the sealant act as supporters, and the liquid crystals and the plurality of supporting components at the outer side of the sealant also act as supporters, so that the supporting conditions at the two sides of the sealant are consistent. Consequently, the forces applied to the inner side and the outer side of the sealant are the same, which may avoid occurrence of deformation of the array substrate and the color filter substrate during they are aligned and assembled to form a cell, so that a final display panel with a uniform cell gap on the periphery thereof may be formed, and thus various adverse effects caused by a non-uniform cell gap may be avoided.

It will be appreciated that the above implementations are only exemplary implementations for illustrating the principle of the disclosure, and the present disclosure is not limited to them. An ordinary person skilled in the art may make various modifications and improvements without departing from the spirit and essence of the present disclosure. The modifications and the improvements should be considered as the protective scope of the present disclosure.

1. A display-panel motherboard comprising a first motherboard and a second motherboard arranged opposite to each other, wherein
the display-panel motherboard is divided into a plurality of sub-panel regions arranged in an array, and a surrounding region other than all of the sub-panel regions,
sealing glue for bonding the first motherboard to the second motherboard is applied within the surrounding region on a periphery of the display-panel motherboard,
each sub-panel region is provided therein with sealant for bonding the first motherboard to the second motherboard, and
first liquid crystals are provided within a closed space between the first motherboard and the second motherboard at an inner side of the sealing glue and at an outer side of the sealant within the individual sub-panel regions.

2. The display-panel motherboard of claim 1, further comprising a plurality of supporting components provided within the closed space between the first motherboard and the second motherboard at an inner side of the sealing glue and at an outer side of the sealant within the individual sub-panel regions.

3. The display-panel motherboard of claim 2, wherein the plurality of supporting components are arranged in an array.

4. The display-panel motherboard of claim 2, wherein the supporting components are made of a photosensitive polymer material which is doped into the first liquid crystals.

5. The display-panel motherboard of claim 4, wherein the photosensitive polymer material is an acrylic material or a polyimide material.

6. The display-panel motherboard of claim 4, wherein the first liquid crystals are doped with polymerization catalyst.

7. The display-panel motherboard of claim 1, wherein the first motherboard is an array-substrate motherboard, and the second motherboard is a color filter-substrate motherboard; or, the first motherboard is a color filter-substrate motherboard, and the second motherboard is an array-substrate motherboard.

8. A method for fabricating a display-panel motherboard, comprising steps:
dividing a first motherboard into a plurality sub-panel regions arranged in an array and a surrounding region other than all of the sub-panel regions;
applying sealing glue within the surrounding region on a periphery of the first motherboard;
dripping liquid crystals into a region enclosed by the sealing glue; and
aligning and assembling the first motherboard and the second motherboard to form a cell so as to form a display-panel motherboard.

9. The method of claim 8, wherein, before the step of aligning and assembling the first motherboard and the second motherboard to form a cell, the method further comprises a step of:
forming a plurality of supporting components within a region at an inner side of the sealing glue and an outer side of sealant within the individual sub-panel regions.

10. The method of claim 9, wherein the step of forming a plurality of supporting components within a region at an inner side of the sealing glue and an outer side of sealant within the individual sub-panel regions comprises:
doping a photosensitive polymer material into liquid crystals within the region at the inner side of the sealing glue and the outer side of the sealant within the individual sub-panel regions; and
irradiating the photosensitive polymer material with light having a predetermined wavelength via a mask, so as to form the plurality of supporting components at exposure positions.

11. The method of claim 10, wherein the step of forming a plurality of supporting components within a region at an inner side of the sealing glue and an outer side of sealant within the individual sub-panel regions further comprises:
doping polymerization catalyst into the liquid crystals within the region at the inner side of the sealing glue and the outer side of the sealant within the individual sub-panel regions.

12. The method of claim 10, wherein, before the step of irradiating the photosensitive polymer material with light having a predetermined wavelength via a mask, the method comprises:
acquiring a distribution of cell gaps between the first motherboard and the second motherboard;
the step of irradiating the photosensitive polymer material with light having a predetermined wavelength via a mask comprises:
preparing a corresponding mask based on the acquired distribution, and irradiating the photosensitive polymer material with light having a predetermined wavelength via the mask to adjust a distribution of the supporting components.

13. The method of claim 10, wherein the light having a predetermined wavelength is ultraviolet light.

14. The method of claim 10, wherein the photosensitive polymer material is an acrylic material or a polyimide material.

15. The method of claim 8, wherein the first motherboard is an array-substrate motherboard, and the second motherboard is a color filter-substrate motherboard; or, the first motherboard is a color filter-substrate motherboard, and the second motherboard is an array-substrate motherboard.

16. The display-panel motherboard of claim 2, wherein the first motherboard is an array-substrate motherboard, and the second motherboard is a color filter-substrate motherboard; or, the first motherboard is a color filter-substrate motherboard, and the second motherboard is an array-substrate motherboard.

17. The display-panel motherboard of claim 3, wherein the first motherboard is an array-substrate motherboard, and the second motherboard is a color filter-substrate motherboard; or, the first motherboard is a color filter-substrate motherboard, and the second motherboard is an array-substrate motherboard.

18. The display-panel motherboard of claim 4, wherein the first motherboard is an array-substrate motherboard, and the second motherboard is a color filter-substrate motherboard; or, the first motherboard is a color filter-substrate motherboard, and the second motherboard is an array-substrate motherboard.

19. The method of claim 9, wherein the first motherboard is an array-substrate motherboard, and the second motherboard is a color filter-substrate motherboard; or, the first motherboard is a color filter-substrate motherboard, and the second motherboard is an array-substrate motherboard.

20. The method of claim 10, wherein the first motherboard is an array-substrate motherboard, and the second motherboard is a color filter-substrate motherboard; or, the first motherboard is a color filter-substrate motherboard, and the second motherboard is an array-substrate motherboard.
